(19) United States
(12) Patent Application Publication
(10) Pub. No.: US 2006/0047131 A1
(43) Pub. Date: Mar. 2, 2006

(54) Continuous splitting process to produce free fatty acids

(76) Inventors: Reynaldo Dias De Moraes E Silva, Brasilia (BR); Karl Hampton, Washington, DC (US)

Correspondence Address: Amelia B. Yarbrough, Ph. D., 8613 Sapienza Dr., Fort Washington, MD, 20744, US

(21) Appl. No.: 10/923,968

(22) Filed: Aug. 24, 2004

(51) Int. Cl. C11C 1/06

(52) U.S. Cl. 554/156

(57) ABSTRACT

This application refers to an industrial production process to split free fatty acids from glycerol by hydrolysis of the glyceryl esters of vegetable oils at an approximate temperature of 60° C., at atmospheric pressure, in a column packed with calcium and magnesium oxide (CaO.MgO) stones, 1/15 of the column diameter as heterogeneous catalyst. The vegetable oil is emulsionated very finely with water at 60° C. and is poured at the top of the column packed with the stones of heterogeneous catalyst. The oil flows through the catalyst stones down into the column, splitting by hydrolysis the molecules of glyceryl esters and separating the fatty acids from the trialcohol (glycerol—C3H5 (OH)3). Both products are collected at the bottom of the column and separated by density difference. The fatty acids obtained have many industrial uses mostly for the production of toilet soap.

### REFERENCES CITED

Swern, Daniel et al in “Baileys Industrial Oil and Fat Products”, John Wiley & Sons, Inc. USA, 1964, p. 797 Fuller, Glenn in “Animal and vegetable Oils, Fats and Waxes”—Riegel's Handbook of Industrial Chemistry Edited by James Kent, 8th Edition, 1982, p. 439,

1. Technical Field

The present invention refers to a new process for splitting fatty acids from glicerides of vegetable oils of any nature by the hydrolysis at 60° C. and atmospheric pressure using a high contact area between reactants and catalyst to allow the production of toilet soap and many other industrial products from free fatty acids.

2. Background Art

So far, the splitting of fatty acids through the hydrolysis reaction of glyceryl ester components of vegetable oils to produce free fatty acids was only obtained at the temperature of 250° C. and 49 kg/cm² of pressure (Mills process) as a hydrolytic process to produce fatty acids as raw material to manufacture toilet soap from vegetable, animal oil and fats, using only 1% of catalyst, generally sodium or potash hydroxide (NaOH or KOH). FULLER wrote, “Over the years, fatty acids have been produced by four basic processes, i.e., saponification of fats followed by acidulation, the Twitchell Process, batch autoclave splitting, and continuous high-pressure, high temperature hydrolysis.”

The processes developed for the production of toilet soaps with fatty acids, patented between 1935 and 1940, by Procter & Gamble and Colgate Palmolive (Mills process), used the splitting of fatty acids and glycerol with the continuous process of hydrolysis in insulated towers at high temperatures with superheated steam (240° C.) at high pressure (49 kg/cm²) in counter flow during 2 to 3 hours.

The production of fatty acids in Europe by splitting using the hydrolysis reaction was carried out in an autoclave where the oil-water mixture was submitted to a temperature of 250° C. at 10 kg/cm² in a batch process during 5 to 6 hours. Another process known in the USA as the TWITCHELL Process is no longer used. This is also a batch process, submitted to the oil-water mixture with 0.1 to 0.2% of sulfuric acid during 36 to 48 hours to saturate steam at atmospheric pressure. This process was important before the Second World War.

### DISCLOSURE OF THE INVENTION

However, according to the present inventors' study, a new process was needed to avoid high-energy costs and the low speed of the reaction. This process should include a new splitting process based on the use of a low cost and abundant catalyst, the CaO.MgO in stones, extended contact between reactants and catalyst, and, consequently, the splitting of fatty acids by the reaction of hydrolysis at low energy costs and high reaction speed.

The theoretical principle is based on the heterogeneous catalysis that presents the characteristic of ionic transitory exchange between the catalyst and reactants, using calcium and magnesium oxide (CaO.MgO) as the heterogeneous catalyst in stones that are 1/15 of the column diameter, thus increasing the contact area between the very finely divided emulsion of water and oil and the catalyst (Cao.MgO). This process intensifies the ionic exchange, and accelerates the hydrolysis process, which occurs almost instantly (2.5 seconds) during the fall through the catalyst stones into a one-meter high bed. SWERN et al wrote, “If the catalyst is a solid, however, its behavior will depend not only upon its chemical composition, but also to a very large degree upon both the nature and extent of its surface.” “In heterogeneous catalysis it is now generally assumed that reaction proceeds through the formation of unstable intermediate compounds or absorption complexes, in which the catalyst is temporarily combined with one or more of the reactants.”

The use of a large contact area between the reactants, with a low cost heterogeneous catalyst as is CaO.Mg.O as a column-packer, drastically reduced the hydrolysis time at the low temperature of 60° C., at atmospheric pressure, in such a way that at the bottom of the column the separation of fatty acids and the glycerol is complete, making fatty acids production feasible, at very low costs, high yields and easily scalable.

The chemical reaction of the process is the following:
C3H5(OOCR)3+3 HOH=C3H5(OH)3+3 HOOCR

The main differences of this process to other splitting processes that guarantee its originality are:
a) The process is a continuous process through a packed column with a low cost and abundant catalyst.
b) The packed columns allow the quadratic projection of its capacity whithout affecting the chemical reactions and resulting products.
c) With this process, it is easier to skip stages for designing a high capacity industrial plants, because there is no need for scaling-up the batch process.
d) This process obtained yields much higher than in other processes, (96% to 98%) because of the perfect separation by hydrolysis, and near the stechiometric yield.
e) The process is much more economical and less costly than any other presently known process for splitting fatty acids and glycerol from vegetable and animal fats and oils, and fixed investments for the same capacity production are much lower than in the presently used process.

1. The process splits fatty acids through the hydrolysis reaction of the mono, bi and triglicerides of vegetable oils at low temperature and atmospheric pressure using high contact area between reactants and catalyst;

2. The process uses a heterogeneous catalyser (CaO.MgO) in stones that are 1/15 of the column diameter with a great contact area between reactants and catalyst;

3. The process claims (1) and (2) produces free fatty acids in a continuous process. This process is scalable, based only on laboratory test parameters.

4. The process claims (1), (2) and (3) by the speed of the hydrolysis reaction occurs almost instantly, about (2.5 seconds) passing through the catalyst bed with the height of only 1.0 meter;

5. The process claims (1), (2), (3) and (4) obtained yields around 98% near stechiometric yield;
